(19) United States
(12) Patent Application Publication
(10) Pub. No.: US 2005/0212734 A1
(43) Pub. Date: Sep. 29, 2005

(54) Drive method of spatial light modulator array, light modulating device and image forming apparatus

(75) Inventor: Koichi Kimura, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/075,686

(22) Filed: Mar. 10, 2005

(30) Foreign Application Priority Data
Mar. 11, 2004 (JP) P.2004-068521

(51) Int. Cl. G09G 3/34

(52) U.S. Cl. 345/84

(57) ABSTRACT

A drive method of a light modulator array in which a time of an ON state and a time of an OFF state can always be made constant. In the case where the optical output of an image forming apparatus is switched from ON to ON, from ON to OFF, from OFF to ON, or from OFF to OFF based on an image desired to be formed, a movable mirror is forcibly brought into an OFF before switching, and the switching to the optical output ON is started in this state.

This application is based on Japanese Patent application JP 2004-068521, filed Mar. 11, 2004, the entire content of which is hereby incorporated by reference. This claim for priority benefit is being filed concurrently with the filing of this application.

### BACKGROUND OF THE INVENTION

1. Technical Field of the Invention

The present invention relates to a drive method of a spatial light modulator array in which plural light modulators each including a storage part for storing drive data and a light modulating part capable of taking, according to the drive data, at least an ON state to allow light to be emitted and an OFF state to prohibit light from being emitted are arranged, a light modulating device including the spatial light modulator array, and an image forming apparatus using the light modulating device.

2. Description of the Related Art

In the related art, as a light modulator, there is known a liquid crystal element, an electro-optic crystal element, a magneto-optic crystal element, a light modulator by MEMS (Micro Electro Mechanical System) technique, or the like. Especially, since the light modulator by the MEMS technique has features of high speed responsiveness, high integration, usability for light in a wide wavelength range and the like, the frequency of use thereof becomes high in an on-demand type digital exposure head used for a photolithography process. Above all, a light modulator by electrostatic drive MEMS is very excellent in high speediness, electric power saving, and high integration, and the element itself has a latch function, so that next image data can be written in a memory while an optical modulation state is kept, and the element is suitable for high-speed driving.

Hereinafter, as an example of a related art spatial light modulator by electrostatic drive MEMS, a description will be given to a reflection type deflecting mirror element typified by a DMD (Digital Micromirror Device). A technique on the DMD and a DMD array in which plural DMDs are arranged is disclosed in detail in JP-A-6-124341.

FIG. 9 is a view showing a rough structure of an SLM (Spatial Light Modulator) by a reflection type deflecting mirror system.

As shown in FIG. 9, an SLM 70 includes a drive circuit 72 formed on a silicon substrate 71 and having a memory function, a first fixed electrode 73 and a second fixed electrode 74 formed on the drive circuit 72 through a not-shown insulating film, a movable mirror 76 facing the first fixed electrode 73 and the second fixed electrode 74 through a space and supported by a hinge part 75, which is supported by a support part (not shown) erectly provided on the silicon substrate 71, in such a manner that it can be elastically displaced relatively to the silicon substrate 71, and two pads 77.

The first fixed electrode 73 and the second fixed electrode 74 are respectively connected to the output of the drive circuit 72. An address voltage Va1 corresponding to drive data (data to specify a displacement state of the movable mirror 76) is outputted from the drive circuit 72 to the first fixed electrode 73, and an address voltage Va2 corresponding to the drive data is outputted from the drive circuit 72 to the second fixed electrode 74.

The hinge part 75 and the movable mirror 76 are respectively made of conductive material (normally, metal such as aluminum having high reflectivity), and function also as a movable electrode. A drive bias voltage Vb is applied to the hinge part 75 and the movable mirror 76 from an after-mentioned drive control part. The movable mirror 76 is displaced by electrostatic force, which is generated between the first fixed electrode 73/the second fixed electrode 74 and the movable mirror 76 by the address voltages Va1 and Va2 applied to the first fixed electrode 73 and the second fixed electrode 74 and the drive bias voltage Vb applied to the hinge part 75 and the movable mirror 76, in a direction varying according to the torsion elasticity of the hinge part 75 (a right direction and a left direction in FIG. 9 with reference to the state in which the movable mirror 76 is in parallel to the silicon substrate 71), and takes an ON state and an OFF state in an alternative way. The ON state is such a state that light emitted from a light source, incident on the movable mirror 76 and reflected therefrom reaches an image formation surface (sensitized material, screen, etc.), and the OFF state is such a state that light emitted from the light source, incident on the movable mirror 76 and reflected there from does not reach the image formation surface. Incidentally, the movable mirror 76 may be such that it does not take the ON state and the OFF state in an alternative way, but can take the ON state, the OFF state and a state between them. The state between them is such a state that for example, half of the light reaches the image formation surface and the remaining half does not reach.

The drive circuit 72 includes a memory circuit for storing the drive data, and outputs the address voltages Va1 and Va2 corresponding to the drive data stored in the memory circuit to the first fixed electrode 73 and the second fixed electrode 74.

FIGS. 10A to 10C are views showing a rough structure in a case where a light modulating device including an SLM array in which plural SLMs 70 are disposed on the same plane is mounted in an image forming apparatus such as an exposure device or a projector.

An image forming apparatus 80 includes a light source 82 such as a laser, a high pressure mercury lamp, or a short arc lamp, the light modulating device, and a projection optical system 81 constructed of a microlens array and the like for projecting light onto a sensitized material or a screen as an image formation surface. The image forming apparatus 80 performs optical modulation by causing light from the light source 82 to be incident on the movable mirror 76 of the SLM 70, and by causing reflected light from the movable mirror 76 to be incident on the projection optical system 81 or not to be incident on the projection optical system 81, and forms an image on an image formation surface.

In the image forming apparatus 80 of FIGS. 10A to 10C, as shown in FIG. 10A, in a state where the movable mirror 76 is tilted left and is in contact with the pad 77 (this state is called a left final displacement state), reflected light is incident on the projection optical system 81, and the light reaches the image formation surface. As shown in FIG. 10B, in a state where the movable mirror 76 is not tilted in either direction, the reflected light is not incident on the projection optical system 81, and the light does not reach the image formation surface. As shown in FIG. 10C, in a state where the movable mirror 76 is tilted right and is in contact with the pad 77 (this state is called a right final displacement state of the movable mirror 76), the reflected light is not incident on the projection optical system 81, and the light does not reach the image formation surface.

The state where the light reaches the image formation surface (the image forming apparatus 80 emits light) is expressed such that the optical output of the image forming apparatus 80 is ON, and the state of the movable mirror 76 in which the optical output of the ON is obtained is defined as an ON state. A state in which light does not reach the image formation surface (the image forming apparatus 80 does not emit light) is expressed such that the optical output of the image forming apparatus 80 is OFF, and the state of the movable mirror 76 in which the optical output of the OFF is obtained is defined as an OFF state. In the case where the definition is made in this way, when the movable mirror 76 transitions from the left final displacement state to the right final displacement state, the optical output of the image forming apparatus 80 is not immediately changed from ON to OFF, and the ON continues for a while, and is changed to the OFF at a time point when the displacement of the movable mirror 76 exceeds a certain position (this position is called an optical threshold). The same applies to a reverse case, and when the movable mirror 76 transitions from the right final displacement state to the left final displacement state, the optical output of the image forming apparatus 80 is not immediately changed from OFF to ON, and the OFF continues for a while and is changed to the ON at a time point when the displacement of the movable mirror 76 exceeds the optical threshold.

Incidentally, the SLM 70 has a latch function to keep the state of the movable mirror 76 even if new drive data is written in the memory circuit at the time when the movable mirror 76 is in the left final displacement state or the right final displacement state.

Hereinafter, the operation of the image forming apparatus 80 equipped with the related art light modulating device will be described.

FIGS. 11A to 1D are timing charts for explaining the operation of the image forming apparatus 80 equipped with the related art light modulating device.

FIG. 11A is a timing chart at the time when the optical output of the image forming apparatus 80 is switched from ON to ON based on an image, FIG. 11B is a timing chart at the time when the optical output of an image forming apparatus 80 is switched from OFF to ON based on the image, FIG. 11C is a timing chart at the time when the optical output of the image forming apparatus 80 is switched from ON to OFF based on an image, and FIG. 11D is a timing chart at the time when the optical output of the image forming apparatus 80 is switched from OFF to OFF based on an image. In FIGS. 11A to 11D, it is assumed that when the movable mirror 76 is in the left final displacement state, the displacement of the movable mirror 76 is ON, and when the movable mirror is in the right final displacement state, the displacement of the movable mirror 76 is OFF.

In the case of FIG. 11A, when the displacement of the movable mirror 76 is ON, drive data (data for causing the displacement of the movable mirror 76 to be ON) based on an image is written in the memory circuit of the SLM 70. After writing, when the drive bias voltage Vb applied to the hinge part 75 of the SLM 70 in which the drive data based on the image is written and the movable mirror 76 is lowered for a specified time, the movable mirror 76 keeps the displacement ON in accordance with the address voltages Va1 and Va2 corresponding to the drive data based on the image, and the image forming apparatus 80 also keeps the optical output ON. When the displacement of the movable mirror 76 is ON, drive data based on a new image is written.

In the image forming apparatus 80, a period from a time when the drive bias voltage Vb is lowered and the movable mirror 76 is displaced according to the drive data based on the image to a time when the drive bias voltage Vb is again lowered and the movable mirror 76 is displaced according to the drive data based on the new image is made a drive cycle Tc, and this drive cycle Tc is repeated. In FIGS. 11A to 1D, Tw(d) denotes a writing time of drive data. Tr(d) is a time in which the displacement of the movable mirror 76 changes from ON to OFF or from OFF to ON, and this time becomes a response time of the movable mirror 76.

In the case of FIG. 11B, when the displacement of the movable mirror 76 is OFF, drive data (data for causing the displacement of the movable mirror 76 to be ON) based on an image is written in the memory circuit of the SLM 70.

After writing, when the drive bias voltage applied to the hinge part 75 of the SLM 70 in which the drive data based on the image is written and the movable mirror 76 is lowered for a specified time, the displacement of the movable mirror 76 transitions from OFF to ON in accordance with the address voltages Va1 and Va2 corresponding to the drive data based on the image, and at a time point when the displacement exceeds the optical threshold and is placed on the ON side, the movable mirror 76 is brought into the ON state, and the optical output of the image forming apparatus 80 also becomes ON. When the displacement of the movable mirror 76 is ON, drive data based on a new image is written and the drive cycle Tc is ended.

In the case of FIG. 1C, when the displacement of the movable mirror 76 is ON, drive data (data for causing the displacement of the movable mirror 76 to be OFF) based on an image is written in the memory circuit of the SLM 70. After writing, when the drive bias voltage Vb applied to the hinge part 75 of the SLM 70 in which the drive data based on the image is written and the movable mirror 76 is lowered for a specified time, the displacement of the movable mirror 76 transitions from ON to OFF in accordance with the address voltages Va1 and Va2 corresponding to the drive data based on the image, and at a time point when the displacement exceeds the optical threshold and is placed on the OFF side, the movable mirror 76 is brought into the OFF state, and the optical output of the image forming apparatus 80 also becomes OFF. When the displacement of the movable mirror 76 is OFF, drive data based on a new image is written and the drive cycle Tc is ended.

In the case of FIG. 1D, when the displacement of the movable mirror 76 is OFF, drive data (data for causing the displacement of the movable mirror 76 to be OFF) based on an image is written in the memory circuit of the SLM 70. After writing, when the drive bias voltage Vb applied to the hinge part 75 of the SLM 70 in which the drive data based on the image is written and the movable mirror 76 is lowered for a specified time, the movable mirror 76 keeps the displacement OFF in accordance with the address voltages Va1 and Va2 corresponding to the drive data based on the image, and the optical output of the image forming apparatus 80 also keeps OFF. When the displacement of the movable mirror 76 is OFF, drive data based on a new image is written, and the drive cycle Tc is ended.

In the SLM 70, it takes some time for the displacement of the movable mirror 76 to change from ON to OFF or from OFF to ON. Thus, as shown in FIG. 11B, in the case where the optical output of the image forming apparatus 80 is switched from OFF to ON, OFF is slightly included in the drive cycle in which the optical output must be ON. Accordingly, in the case where the optical output is desired to become ON, unevenness occurs in the time of ON according to the drive state of the former drive cycle Tc. In the case where the light modulating device is used for an exposure head of an exposure device for forming a latent image on a photosensitive material, the unevenness causes unevenness in the amount of light. The unevenness in the amount of light becomes particularly noticeable when Tr(d) is large as compared with Tc. For example, in the case where a writing clock F of drive data writing is F=100 MHz, and the number M of rows of the SLM array is M=400, when it is assumed that writing of drive data is performed in every row, the drive cycle Tc becomes Tc=Tw(d)*M=F*M=4 μs. When the time Tr(d) is made Tr(d)=1 μs, an unevenness of approximately 1/4 in the amount of light occurs, and it becomes a serious problem for the exposure device. This is not limited to the exposure device, and also in a projection device or the like, this causes unevenness in brightness, and becomes a problem.

Besides, as shown in FIG. 11C, in the case where the optical output of the image forming apparatus 80 is switched from ON to OFF, ON is slightly included in the drive cycle Tc in which the optical output must be made OFF. Accordingly, in the case where the optical output is desired to be made OFF, there is a case where ON is partially included in the time of the OFF state according to the drive state of the former drive cycle Tc, and this results in leak light, and causes a lowering of contrast. This lowering of contrast becomes a problem especially in the case where the light modulating device is used for the exposure head of the exposure device. Besides, this is not limited to the exposure device, and also in the projection device or the like, this causes unevenness in brightness and the lowering of contrast, and becomes a problem.

These problems are not limited to the reflection type deflecting mirror element such as the SLM, or the light modulator of the micro-electro-mechanical control system which includes the fixed electrode and the movable part including the opposite electrode opposite thereto, and in which the movable part is elastically deformed according to the electrostatic force generated by applying voltage to both the electrodes, and transmission and non-transmission of light is controlled, and these are common problems in light modulators in which the response time Tr (d) exists. As a light modulator in which the response time Tr(d) exists, a liquid crystal element, an electro-optic crystal element, a magneto-optic crystal element and the like can be listed. The invention has been made in view of the above circumstances.

### SUMMARY OF THE INVENTION

An object of the invention is to provide a drive method of a spatial light modulator array in which a time of an ON state or an OFF state based on an image canal ways be made constant.

A drive method of a spatial light modulator array of the invention in which the spatial light modulator array includes plural arranged light modulators each including a storage part for storing drive data and a light modulating part capable of taking at least an ON state to allow light to be emitted and an OFF state to prohibit light from being emitted according to the drive data, the drive data is written in the storage part, and a state of the light modulating part is changed according to the written drive data to perform light modulation, and in which a control is performed to cause the light modulating part to have the OFF state in a period from a time when the light modulating part is caused to transition to a state corresponding to the drive data based on an image to a time when the light modulating part is caused to transition to a state corresponding to the drive data based on a new image, and in this state, the light modulating part is caused to transition to the state corresponding to the drive data based on the new image.

By this method, the time in which the light modulating part is made to have the ON state or the OFF state based on the image can always be made constant.

Besides, in the drive method of the spatial light modulator array, the control is preferably performed by writing OFF state drive data, which causes the light modulating part to have the OFF state, into the storage part, and by changing the light modulating part into the OFF state according to the written OFF state drive data.

Besides, in the drive method of the spatial light modulator array of the invention, the light modulator preferably causes the light modulating part to have the OFF state according to input of a specified signal independently of the drive data stored in the storage part, and the control is performed by changing the light modulating part into the OFF state by the input of the specified signal.

Besides, in the drive method of the spatial light modulator array of the invention, even in a case where the specified signal is inputted, the storage part preferably keeps the drive data based on the new image.

Besides, in the drive method of the spatial light modulator array of the invention, the light modulating part preferably includes a movable part supported to be capable of being elastically displaced and provided with a movable electrode in at least a part, and a fixed electrode disposed to face the movable part, and can take at least the ON state and the OFF state by displacing the movable part by an electrostatic force generated according to application of a drive voltage to the movable electrode and the fixed electrode.

Besides, in the drive method of the spatial light modulator array of the invention, the control is preferably performed by controlling the drive voltage applied to at least one of the movable electrode and the fixed electrode.

Besides, in the drive method of the spatial light modulator array of the invention, the movable part preferably includes a mirror capable of being displaced in a direction varying according to the electrostatic force, the mirror is tilted in a specified direction in a final state of the ON state, and is tilted in a direction opposite to the specified direction in a final state of the OFF state, and the control is performed by controlling the drive voltage to produce a state in which the mirror is not tilted in either of the specified direction and the opposite direction.

Besides, in the drive method of the spatial light modulator array of the invention, the light modulator preferably includes a movable part supported to be capable of being elastically displaced and provided with a movable electrode in at least a part, and a fixed electrode disposed to face the movable part, and can take at least the ON state and the OFF state by displacing the movable part by an electrostatic force generated by application of a drive voltage to the movable electrode and by application of a voltage to the fixed electrode according to the drive data, and the movable part includes a mirror capable of being displaced in a direction varying according to the electrostatic force.

Besides, in the drive method of the spatial light modulator array of the invention, the light modulator preferably has a latch function to keep the state even in a case where the drive data is written in the storage part when the light modulating part is in one of the ON state and the OFF state.

Besides, in the drive method of the spatial light modulator array of the invention, writing of at least a part of the drive data based on the new image into the storage part is preferably performed when the light modulating part is in the OFF state.

A light modulating device of the invention includes a spatial light modulator array in which plural light modulators each including a storage part for storing drive data and a light modulating part capable of taking at least an ON state to allow light to be emitted and an OFF state to prohibit light from being emitted according to the drive data are arranged, and a light modulating control part which causes the drive data to be written in the storage part, causes a state of the light modulating part to be changed according to the written drive data, and causes light modulation to be performed, wherein the light modulating control part performs a control to cause the light modulating part to have the OFF state in a period from a time when the light modulating part is caused to transition to a state corresponding to the drive data based on an image to a time when the light modulating part is caused to transition to a state corresponding to the drive data based on a new image, and causes, in this state, the light modulating part to transition to the state corresponding to the drive data based on the new image.

By this structure, the time in which the light modulating part is made to have the ON state or the OFF state based on the image can always be made constant.

Besides, in the light modulating device of the invention, the light modulating control part preferably performs the control by writing OFF state drive data, which causes the light modulating part to have the OFF state, into the storage part, and by changing the light modulating part into the OFF state according to the written OFF state drive data.

Besides, in the light modulating device of the invention, the light modulator preferably causes the light modulating part to have the OFF state according to input of a specified signal independently of the drive data stored in the storage part, and the light modulating control part performs the control by changing the light modulating part into the OFF state by the input of the specified signal.

Besides, in the light modulating device of the invention, even in a case where the specified signal is inputted, the storage part preferably keeps the drive data based on the new image.

Besides, in the light modulating device of the invention, the light modulating part preferably includes a movable part supported to be capable of being elastically displaced and provided with a movable electrode in at least a part, and a fixed electrode disposed to face the movable part, and can take at least the ON state and the OFF state by displacing the movable part by an electrostatic force generated according to application of a drive voltage to the movable electrode and the fixed electrode.

Besides, in the light modulating device of the invention, the light modulating control part preferably performs the control by controlling the drive voltage applied to at least one of the movable electrode and the fixed electrode.

Besides, in the light modulating device of the invention, the movable part preferably includes a mirror capable of being displaced in a direction varying according to the electrostatic force, the mirror is tilted in a specified direction in a final state of the ON state, and is tilted in a direction opposite to the specified direction in a final state of the OFF state, and the light modulating control part performs the control by controlling the drive voltage to produce a state in which the mirror is not tilted in either of the specified direction and the opposite direction.

Besides, in the light modulating device of the invention, the light modulator preferably includes a movable part supported to be capable of being elastically displaced and provided with a movable electrode in at least a part, and a fixed electrode disposed to face the movable part, and can take at least the ON state and the OFF state by displacing the movable part by an electrostatic force generated by application of a drive voltage to the movable electrode and by application of a voltage to the fixed electrode according to the drive data, the movable part includes a mirror capable of being displaced in a direction varying according to the electrostatic force, and the light modulating control part controls the drive voltage applied to the movable electrode.

Besides, in the light modulating device of the invention, the light modulator preferably has a latch function to keep the state even in a case where the drive data is written in the storage part when the light modulating part is in one of the ON state and the OFF state.

Besides, in the light modulating device of the invention, the light modulating control part preferably performs writing of at least a part of the drive data based on the new image into the storage part when the light modulating part is in the OFF state.

An image forming apparatus of the invention includes the light modulating device, a light source for causing light to be incident on the spatial light modulator array, and a projection optical system for projecting light emitted from the spatial light modulator array onto an image formation surface.

According to the invention, it is possible to provide the drive method of the spatial light modulator array in which the time of the ON state or the OFF state based on the image can always be made constant.

### BRIEF DESCRIPTION OF THE DRAWINGS

FIG. 1 is a view showing a rough structure of a light modulating device to be mounted in an image forming apparatus such as an exposure device or a projector for explaining a first embodiment of the invention.

FIG. 2 is a view showing an equivalent circuit of a drive circuit of an SLM.

FIGS. 3A to 3D are Timing charts for explaining the operation of the image forming apparatus equipped with the light modulating device for explaining the first embodiment of the invention.

FIGS. 4A to 4D are timing charts for explaining the operation of an image forming apparatus equipped with a light modulating device for explaining a second embodiment of the invention.

FIG. 5 is a view showing an equivalent circuit of a drive circuit of an SLM for explaining a third embodiment of the invention.

FIG. 6 is a view showing an input/output table of an AND circuit included in the drive circuit of the SLM for explaining the third embodiment of the invention.

FIG. 7 is a view showing a rough structure of a light modulating device to be mounted in an image forming apparatus for explaining the third embodiment of the invention.

FIGS. 8A to 8D are timing charts for explaining the operation of the image forming apparatus for explaining the third embodiment of the invention.

FIG. 9 is a view showing a rough structure of a related art SLM.

FIGS. 10A to 10C are views showing a rough structure in a case where a light modulating device including an SLM array in which plural related art SLMs are arranged on the same plane is mounted in an image forming apparatus such as an exposure device or a projector.

FIGS. 11A to 11D are timing charts for explaining the operation of the image forming apparatus equipped with the related art light modulating device.

### DETAILED DESCRIPTION OF THE INVENTION

### First Embodiment

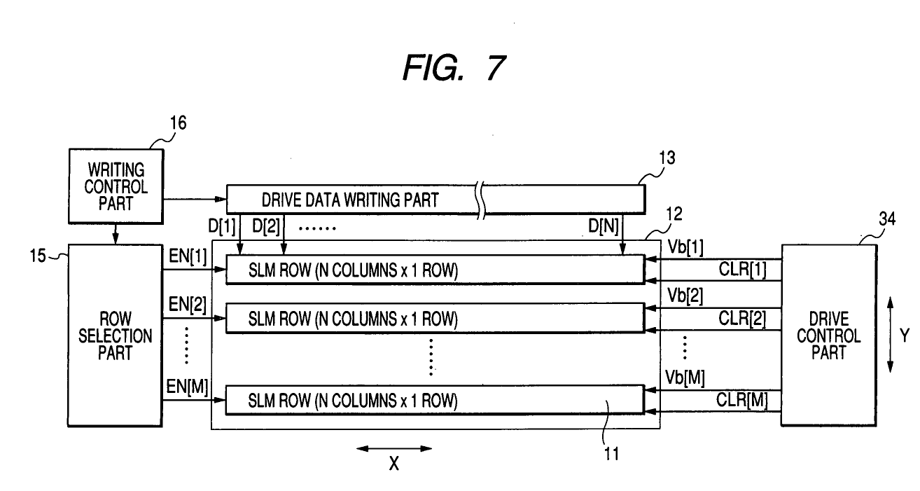

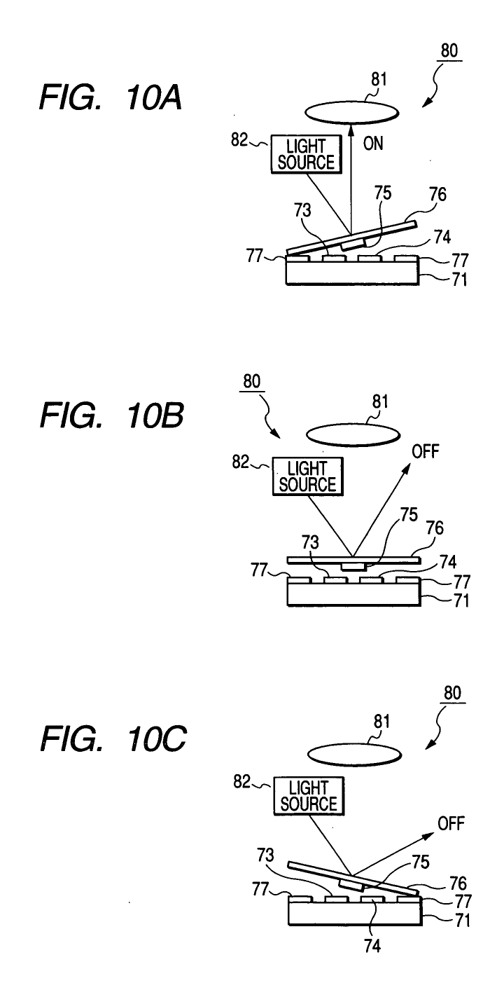

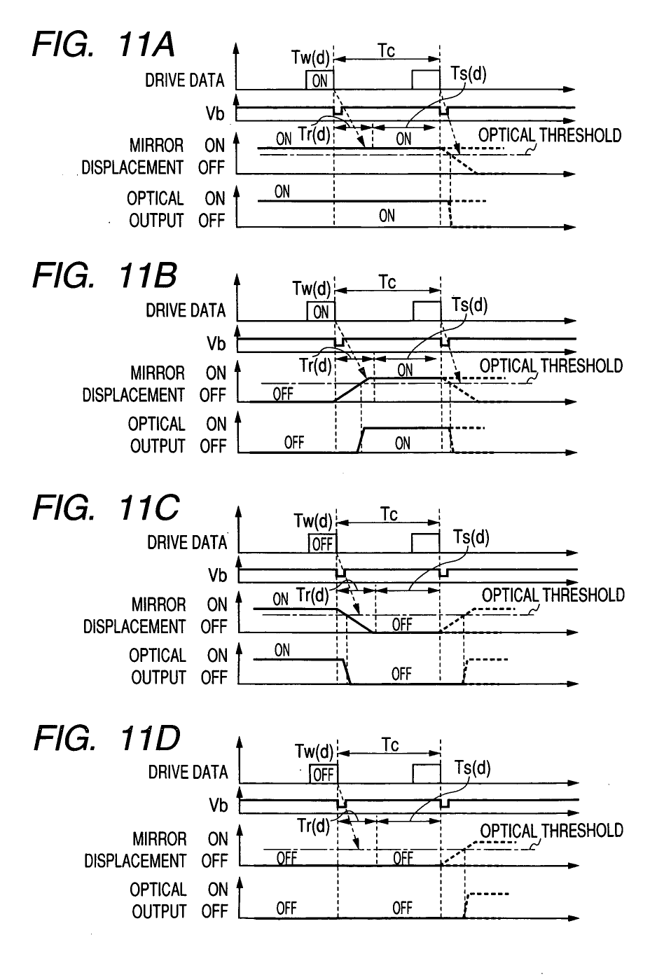

An image forming apparatus, such as an exposure device or a projector, for description of a first embodiment of the invention has the same structure as the image forming apparatus 80 shown in FIGS. 10A to 10C. Thus, in the following, the description will be made while using FIGS. 7, 9 and 10 as the need arises.

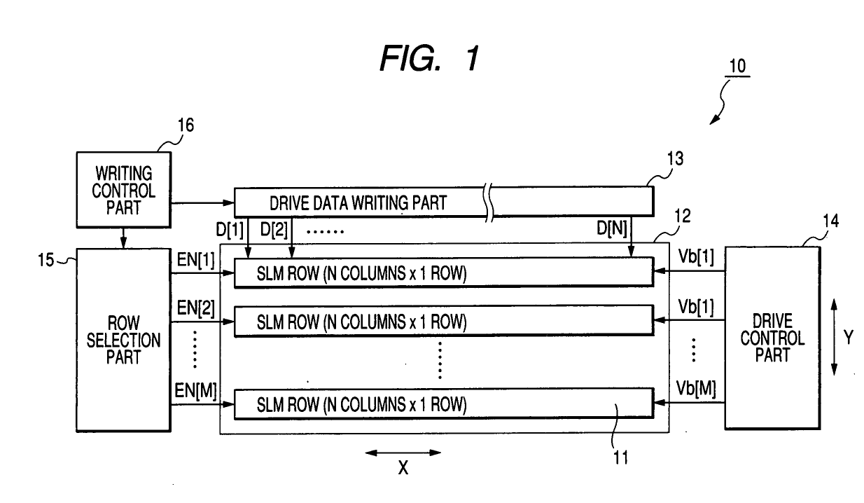

FIG. 1 is a view showing a rough structure of a light modulating device to be mounted in an image forming apparatus such as an exposure device or a projector and for explaining the first embodiment of the invention.

A light modulating device 10 of FIG. 1 includes an SLM array 12 in which M SLM rows 11, in each which N SLMs 70 are arranged in a row direction (X direction of FIG. 1) on the same plane, are arranged in a column direction (Y direction of FIG. 1), a drive data writing part 13 for writing drive data in every SLM row 11, a drive control part 14 for applying a drive bias voltage Vb to a hinge part 75 and a movable mirror 76 of an SLM 70 and controlling the drive bias voltage Vb to control a displacement state of the movable mirror 76, a row selection part 15 for selecting the SLM row 11 into which the drive data is to be written, and a writing control part 16 for controlling the drive data writing part 13 and the row selection part 15.

The drive data writing part 13 writes the drive data into a memory circuit of each of the N SLMs 70 included in the SLM row 11 selected by the row selection part 15 according to a drive clock supplied from the writing control part 16. In FIG. 1, the drive data written into each memory circuit from the drive data writing part 13 is denoted by D[i] (i=1 to N).

The row selection part 15 selects the SLM row 11 into which the drive data is written according to the drive clock supplied from the writing control part 16. In the case where writing is performed in block units, plural SLM rows 11 included in one block are respectively selected. In FIG. 1, a row selection signal for selecting the SLM row 11 is denoted by EN[j] (j=1 to M).

The drive control part 14 applies the drive bias voltage Vb to the hinge part 75 and the movable mirror 76 of each of the N SLMs 70 included in each SLM row 11, and controls the applied drive bias voltage Vb to control the displacement state of the movable mirror 76. In FIG. 1, the drive bias voltage applied to each SLM row 11 is denoted by Vb[j] (j=1 to M).

Incidentally, the control of the drive bias voltage Vb can be performed in a unit of arbitrary rows, such as a unit of a row, a unit of a block of plural rows, or a unit of all rows. For example, in the case of the control in the unit of a row, after the drive data is written into a specified row, the drive bias voltages Vb of the specified row are simultaneously controlled, and the displacement states of the movable mirrors of the specified row are simultaneously controlled. In the case of the control in the unit of a block of plural rows, after the drive data is written into the respective rows of the specified block, the drive bias voltages Vb of the specified block are simultaneously controlled, and the displacement states of the movable mirrors are simultaneously controlled. In the case of the control in the unit of all rows, after drive data is written into all rows, the drive bias voltages Vb of all the rows are simultaneously controlled, and the displacement states of the movable mirrors are simultaneously controlled.

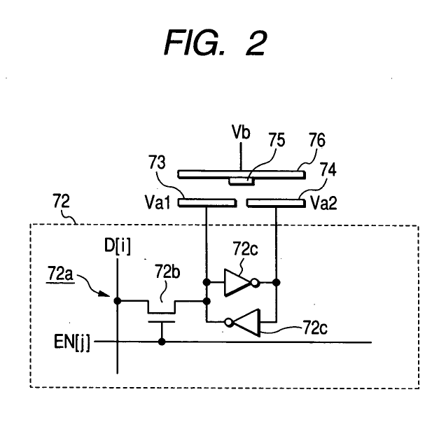

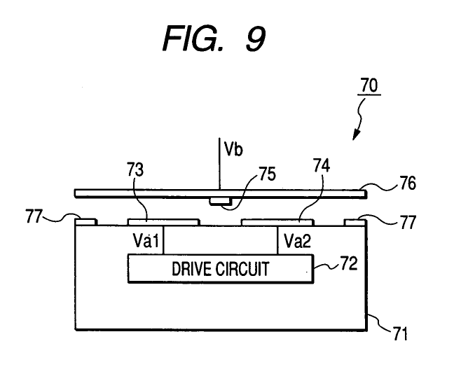

FIG. 2 is a view showing an equivalent circuit of the drive circuit 72 of the SLM 70 shown in FIG. 9.

The drive circuit 72 shown in FIG. 2 includes an SRAN 72a as a memory circuit, and the SRAM 72a includes a transistor 72b and two NOT circuits 72c.

As shown in FIG. 2, the drive data D[i] is supplied through the transistor 72b to the SRAM 72a selected by the row selection signal EN[j], and address voltages Va1 and Va2 corresponding to the drive data D[i] are outputted from the NOT circuits 72c to the first fixed electrode 73 and the second fixed electrode 74. When data Q is written as the drive data, a voltage (for example, 5 V) corresponding to Q is applied to the first fixed electrode 73, and a voltage (for example, 0 V) corresponding to NOTQ(/Q) is applied to the second fixed electrode 74. When data NOTQ(/Q) is written as the drive data, a voltage (for example, 0V) corresponding to NOTQ is applied to the first fixed electrode 73, and a voltage (for example, 5 V) corresponding Q is applied to the second fixed electrode 74.

Hereinafter, the operation of an image forming apparatus 80 equipped with the light modulating device 10 shown in FIG. 1 will be described.

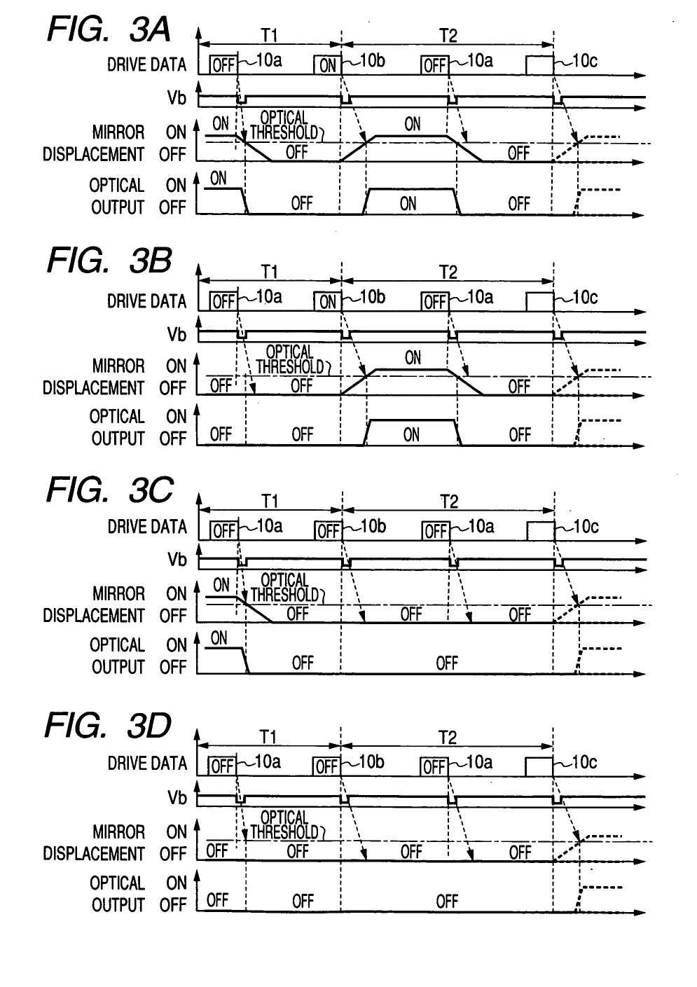

FIGS. 3A to 3D are timing charts for explaining the operation of the image forming apparatus 80 equipped with the light modulating device 10 for explaining the first embodiment of the invention.

FIG. 3A is a timing chart at the time when the optical output of the image forming apparatus 80 is switched from ON to ON based on an image, FIG. 3B is a timing chart at the time when the optical output of the image forming apparatus 80 is switched from OFF to ON based on an image, FIG. 3C is a timing chart at the time when the optical output of the image forming apparatus 80 is switched from ON to OFF based on an image, and FIG. 3D is a timing chart at the time when the optical output of the image forming apparatus 80 is switched from OFF to OFF based on an image. In FIGS. 3A to 3D, it is assumed that when the movable mirror 76 is in a left final displacement state, the displacement of the movable mirror 76 is ON, and when the movable mirror 76 is in a right final displacement state, the displacement of the movable mirror 76 is OFF.

In addition, in FIGS. 3A to 3D, a period in which the optical output of the image forming apparatus 80 is driven to ON or OFF based on an image desired to be formed is denoted by a drive cycle T1 or T2. The light modulating device 10 repeats the drive cycle T1 or T2 and performs the light modulation to form the image on an image formation surface.

In the case of FIG. 3A, in a former drive cycle T1, when the displacement of the movable mirror 76 is ON, the drive data writing part 13 writes drive data 10a (data for causing the displacement of the movable mirror 76 to be OFF) irrelevant to an image into the memory circuit of the SLM 70. After writing, the drive control part 14 lowers the drive bias voltage Vb applied to the hinge part 75 of the SLM 70 in which the drive data 10a is written and the movable mirror 76 for a specified time. By this, the displacement of the movable mirror 76 transitions from ON to OFF, and at a time point when the displacement exceeds the optical threshold and is placed on the OFF side, the movable mirror 76 is brought into the OFF state, and the optical output of the image forming apparatus 80 becomes OFF.

In the drive cycle T1, the drive data writing part 13 writes drive data 10b (data for causing the displacement of the movable mirror 76 to be ON) based on an image into the memory circuit of the SLM 70 when the displacement of the movable mirror 76 is OFF according to the drive data 10a.

After writing, the drive control part 14 lowers the drive bias voltage Vb applied to the hinge part 75 of the SLM 70 in which the drive data 10b based on the image is written and the movable mirror 76 for a specified time. By this, a next drive cycle T2 is started, the displacement of the movable mirror 76 starts to transition from OFF to ON, and at a time point when the displacement exceeds the optical threshold and is placed on the ON side, the movable mirror 76 is brought into the ON state based on the image, and the optical output of the image forming apparatus 80 becomes ON based on the image.

In a drive cycle T2, when the displacement of the movable mirror 76 is ON, the drive data writing part 13 writes drive data 10a(data for causing the displacement of the movable mirror 76 to be OFF) irrelevant to an image into the memory circuit of the SLM 70. After writing, the drive control part 14 lowers the drive bias voltage Vb applied to the hinge part 75 of the SLM 70 in which the drive data 10a is written and the movable mirror 76 for a specified time. By this, the displacement of the movable mirror 76 transitions from ON to OFF, and at a time point when the displacement exceeds the optical threshold and is placed on the OFF side, the movable mirror 76 is brought into the OFF state, and the optical output of the image forming apparatus 80 becomes OFF.

In the drive cycle T2, when the displacement of the movable mirror 76 is OFF according to the drive data 10a, the drive data writing part 13 writes drive data 10c (data for causing the displacement of the movable mirror 76 to be ON or OFF) based on a new image into the memory circuit of the SLM 70, and ends the drive cycle T2.

In the case of FIG. 3B, when the displacement of the movable mirror 76 is OFF in a former drive cycle T1, the drive data writing part 13 writes drive data 10a (data for causing the displacement of the movable mirror 76 to be OFF) irrelevant to an image into the memory circuit of the SLM 70. After writing, the drive control part 14 lowers the drive bias voltage Vb applied to the hinge part 75 of the SLM 70 in which the drive data 10a is written and the movable mirror 76 for a specified time. By this, the displacement of the movable mirror 76 is kept to be OFF, and the optical output of the image forming apparatus 80 keeps OFF.

In the drive cycle T1, when the displacement of the movable mirror 76 is OFF according to the drive data 10a, the drive data writing part 13 writes drive data 10b (data for causing the displacement of the movable mirror 76 to be ON) based on an image into the memory circuit of the SLM 70. After writing, the drive control part 14 lowers the drive bias voltage Vb applied to the hinge part 75 of the SLM 70 in which the drive data 10b is written and the movable mirror 76 for a specified time. By this, a next drive cycle T2 is started, the displacement of the movable mirror 76 starts to transition from OFF to ON, and at a time point when the displacement exceeds the optical threshold and is placed on the ON side, the movable mirror 76 is brought into the ON state based on the image, and the optical output of the image forming apparatus 80 becomes ON based on the image.

In the drive cycle T2, when the displacement of the movable mirror 76 is ON, the drive data writing part 13 writes drive data 10a (data for causing the displacement of the movable mirror 76 to be OFF) irrelevant to an image into the memory circuit of the SLM 70. After writing, the drive control part 14 lowers the drive bias voltage Vb applied to the hinge part 75 of the SLM 70 in which the drive data 10a is written and the movable mirror 76 for a specified time. By this, the displacement of the movable mirror 76 transitions from ON to OFF, and at a time point when the displacement exceeds the optical threshold and is placed on the OFF side, the movable mirror 76 is brought into the OFF state, and the optical output of the image forming apparatus 80 becomes OFF.

In the drive cycle T2, when the displacement of the movable mirror 76 is OFF according to the drive data 10a, the drive data writing part 13 writes drive data 10c (data for causing the displacement of the movable mirror 76 to be ON or OFF) based on a new image into the memory circuit of the SLM 70, and ends the drive cycle T2.

As shown in FIGS. 3A and 3B, according to the light modulating device 10 of this embodiment, in both of the case where the optical output of the image forming apparatus 80 is switched from ON to ON based on the image desired to be formed, and the case where the optical output of the image forming apparatus 80 is switched from OFF to ON based on the image desired to be formed, the movable mirror 76 is once brought into the OFF state before switching, and the switching to the optical output ON of the image forming apparatus 80 is performed in this state, and therefore, the time of the optical output ON after the switching can be made the same. Accordingly, it is possible to prevent unevenness in the amount of light and unevenness in brightness from occurring in the image forming apparatus 80.

In the case of FIG. 3C, in a former drive cycle T1, when the displacement of the movable mirror 76 is ON, the drive data writing part 13 writes drive data 10a (data for causing the displacement of the movable mirror 76 to be OFF) irrelevant to an image into the memory circuit of the SLM 70. After writing, the drive control part 14 lowers the drive bias voltage Vb applied to the hinge part 75 of the SLM 70 in which the drive data 10a is written and the movable mirror 76 for a specified time. By this, the displacement of the movable mirror 76 transitions from ON to OFF, and at a time point when the displacement exceeds the optical threshold and is placed on the OFF side, the movable mirror 76 is brought into the OFF state, and the optical output of the image forming apparatus 80 becomes OFF.

When the displacement of the movable mirror 76 is OFF according to the drive data 10a, the drive data writing part 13 write drive data 10b (data for causing the displacement of the movable mirror 76 to be OFF) based an image into the memory circuit of the SLM 70. After writing, the drive control part 14 lowers the drive bias voltage Vb applied to the hinge part 75 of the SLM 70 in which the drive data 10b is written and the movable mirror 76 for a specified time. By this, a next drive cycle T2 is started, the displacement of the movable mirror 76 is kept to be OFF, the movable mirror 76 is brought into the OFF state based on the image, and the optical output of the image forming apparatus 80 is brought into the OFF state based on the image.

In the drive cycle T2, when the displacement of the movable mirror 76 is OFF according to the drive data 10b, the drive data writing part 13 writes the drive data 10a (data for causing the displacement of the movable mirror 76 to be OFF) irrelevant to an image into the memory circuit of the SLM 70. After writing, the drive control part 14 lowers the drive bias voltage Vb applied to the hinge part 75 of the SLM 70 in which the drive data 10a is written and the movable mirror 76 for a specified time. By this, the displacement of the movable mirror 76 is kept to be OFF, and the optical output of the image forming apparatus 80 keeps OFF.

In the drive cycle T2, when the displacement of the movable mirror 76 is OFF according to the drive data 10a, the drive data writing part 13 writes drive data 10c (data for causing the displacement of the movable mirror 76 to be ON or OFF) based on a new image into the memory circuit of the SLM 70, and ends the drive cycle T2.

In the case of FIG. 3D, in a former drive cycle T1, when the displacement of the movable mirror 76 is OFF, the drive data writing part 13 writes drive data 10a (data for causing the displacement of the movable mirror 76 to be OFF) irrelevant to an image into the memory circuit of the SLM 70. After writing, the drive control part 14 lowers the drive bias voltage Vb applied to the hinge part 75 of the SLM 70 in which the drive data 10a is written and the movable mirror 76 for a specified time. By this, the displacement of the movable mirror 76 is kept to be OFF, and the optical output of the image forming apparatus 80 keeps OFF.

When the displacement of the movable mirror 76 is OFF according to the drive data 10a, the drive data writing part 13 writes drive data 10b (data for causing the displacement of the movable mirror 76 to be OFF) based on an image into the memory circuit of the SLM 70. After writing, the drive control part 14 lowers the drive bias voltage Vb applied to the hinge part 75 of the SLM 70 in which the drive data 10b is written and the movable mirror 76 for a specified time. By this, a next drive cycle T2 is started, the displacement of the movable mirror 76 is kept to be OFF, the movable mirror 76 is brought into the OFF state based on the image, and the optical output of the image forming apparatus 80 becomes OFF based on the image.

In the drive cycle T2, when the displacement of the movable mirror 76 is OFF according to the drive data 10b, the drive data writing part 13 writes drive data 10a (data for causing the displacement of the movable mirror 76 to be OFF) irrelevant to an image into the memory circuit of the SLM 70. After writing, the drive control part 14 lowers the drive bias voltage Vb applied to the hinge part 75 of the SLM 70 in which the drive data 10a is written and the movable mirror 76 for a specified time. By this, the displacement of the movable mirror 76 is kept to be OFF, and the optical output of the image forming apparatus 80 keeps OFF.

In the drive cycle T2, when the displacement of the movable mirror 76 is OFF according to the drive data 10a, the drive data writing part 13 writes drive data 10c (data for causing the displacement of the movable mirror 76 to be ON or OFF) based on a new image into the memory circuit of the SLM 70, and ends the drive cycle T2.

As shown in FIGS. 3C and 3D, according to the light modulating device 10 of this embodiment, in both of the case where the optical output of the image forming apparatus 80 is switched from ON to OFF based on the image desired to be formed, and the case where the optical output of the image forming apparatus 80 is switched from OFF to OFF based on the image desired to be formed, the movable mirror 76 is once brought into the OFF state before switching, and the switching to the optical output OFF of the image forming apparatus 80 is performed in this state, and therefore, the optical output ON is not kept after the switching. Accordingly, the production of leak light can be prevented, unevenness in the amount of light and unevenness in brightness can be prevented from occurring in the image forming apparatus 80, and the lowering of contrast can be prevented.

Additionally, in this embodiment, in the drive cycle T1 or T2, as long as the drive data 10a has been written, the drive data 10b and 10c may be written at any time. However, it is desirable to write them after the movable mirror 76 is brought into the OFF state according to the drive data. Besides, although the drive data 10a may be written at any time in the drive cycle T1 or T2, it is desirable to perform writing after the movable mirror 76 is brought into the ON state or the OFF state according to the drive data based on the image.

Besides, in this embodiment, a period from a time when the displacement of the movable mirror 76 is caused to transition to the state corresponding to the drive data based on the image to a time when it is caused to transition to the state corresponding to the drive data based on the new image corresponds to the drive cycle T1 or T2.

### Second Embodiment

A light modulating device mounted in an image forming apparatus, such as an exposure device or a projector, for the description of a second embodiment of the invention has the same structure as the light modulating device 10 shown in FIG. 1, and therefore, the description will be made while using FIG. 1 as the need arises.

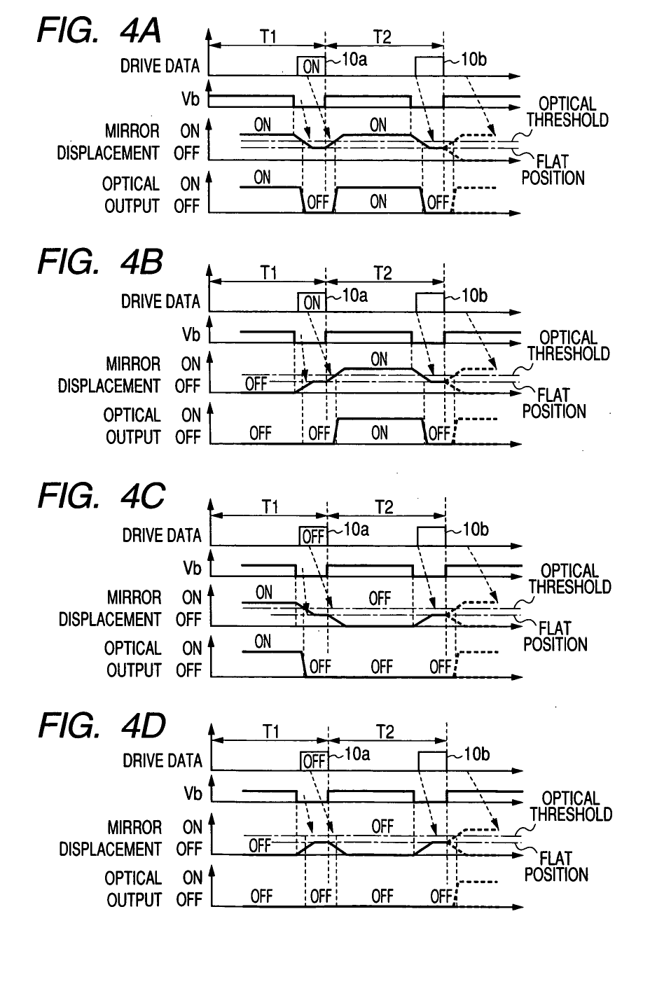

FIGS. 4A to 4D are timing charts for explaining the operation of the image forming apparatus 80 equipped with the light modulating device 10 for explaining the second embodiment of the invention.

FIG. 4A is a timing chart at the time when the optical output of the image forming apparatus 80 is switched from ON to ON based on an image, FIG. 4B is a timing chart at the time when the optical output of the image forming apparatus 80 is switched from OFF to ON based on an image, FIG. 4C is a timing chart at the time when the optical output of the image forming apparatus is switched from ON to OFF based on an image, and FIG. 4D is a timing chart at the time when the optical output of the image forming apparatus 80 is switched from OFF to OFF based on an image. In FIGS. 4A to 4D, it is assumed that when the movable mirror 76 is in a left final displacement state, the displacement of the movable mirror 76 is ON, and when the movable mirror is in a right final displacement state, the displacement of the movable mirror 76 is OFF.

Additionally, in FIGS. 4A to 4D, a period in which the optical output of the image forming apparatus 80 is driven to ON or OFF based on an image desired to be formed is denoted by a drive cycle T1 or T2. The light modulating device 10 repeats this drive cycle T1 or T2, and performs light modulation to form the image on an image formation surface.

In FIG. 4A, in a former drive cycle T1, when the displacement of the movable mirror 76 is ON, the drive control part 14 lowers the drive bias voltage Vb applied to the movable mirror 76 until the displacement of the movable mirror 76 has an intermediate position between ON and OFF, that is, a position parallel to the silicon substrate 71 (this position is referred to as a flat position). By this, the displacement of the movable mirror 76 transitions from ON to the flat position, and at a time point when the displacement exceeds the optical threshold and is placed on the flat position side, the movable mirror 76 is brought into the OFF state, and the optical output of the image forming apparatus 80 becomes OFF.

While the drive bias voltage Vb is lowered, the drive data writing part 13 writes drive data 10a (data for causing the displacement of the movable mirror 76 to be ON) based on an image into the memory circuit of the SLM 70. After writing, the drive control part 14 returns the lowered drive bias voltage Vb to the original one. By this, a next drive cycle T2 is started, the displacement of the movable mirror 76 transitions from the flat position to ON, and at a time point when the displacement exceeds the optical threshold and is placed on the ON side, the movable mirror 76 is brought into the ON state based on the image, and the optical output of the image forming apparatus 80 becomes ON based on the image.

In a drive cycle T2, when the displacement of the movable mirror 76 is ON according to the drive data 10a, the drive control part 14 lowers the drive bias voltage Vb applied to the movable mirror 76 until the displacement of the movable mirror 76 has the flat position. By this, the displacement of the movable mirror 76 transitions from ON to the flat position, and at a time point when the displacement exceeds the optical threshold and is placed on the flat position side, the movable mirror 76 is brought into the OFF state and the optical output of the image forming apparatus 80 becomes OFF.

While the drive bias voltage Vb is lowered, the drive data writing part 13 writes drive data 10b (data for causing the displacement of the movable mirror 76 to be ON or OFF) based on a new image into the memory circuit of the SLM 70, and ends the drive cycle T2.

In the case of FIG. 4B, in a former drive cycle T1, when the displacement of the movable mirror 76 is OFF, the drive control part 14 lowers the drive bias voltage Vb applied to the movable mirror 76 until the displacement of the movable mirror 76 has the flat position. By this, the displacement of the movable mirror 76 transitions from OFF to the flat position, the movable mirror 76 keeps the OFF state, and the optical output of the image forming apparatus 80 keeps OFF.

While the drive bias voltage Vb is lowered, the drive data writing part 13 writes drive data 10a (data for causing the displacement of the movable mirror 76 to be ON) based on an image into the memory circuit of the SLM 70. After writing, the drive control part 14 returns the lowered drive bias voltage Vb to the original one. By this, a next drive cycle T2 is started, and the displacement of the movable mirror 76 transitions from the flat position to ON, and at a time point when the displacement exceeds the optical threshold and is placed on the ON side, the movable mirror 76 is brought into the ON state based on the image, and the optical output of the image forming apparatus 80 becomes ON based on the image.

In the drive cycle T2, when the displacement of the movable mirror 76 is ON according to the drive data 10a, the drive control part 14 lowers the drive bias voltage Vb applied to the movable mirror 76 until the displacement of the movable mirror 76 has the flat position. By this, the displacement of the movable mirror 76 transitions from ON to the flat position, and at a time point when the displacement exceeds the optical threshold and is placed on the flat position side, the movable mirror 76 is brought into the OFF state and the optical output of the image forming apparatus 80 becomes OFF.

While the drive bias voltage Vb is lowered, the drive data writing part 13 writes drive data 10b (data for causing the displacement of the movable mirror 76 to be ON or OFF) based on a new image into the memory circuit of the SLM 70, and ends the drive cycle T2.

As shown in FIGS. 4A and 4B, in both of the case where the optical output of the image forming apparatus 80 is switched from ON to ON based on the image desired to be formed, and the case where the optical output of the image forming apparatus 80 is switched from OFF to ON based on the image desired to be formed, the drive bias voltage Vb is lowered before switching, the movable mirror 76 is once brought into the OFF state, and switching to the optical output ON of the image forming apparatus 80 is performed in this state, and therefore, the time of the optical output ON after the switching can be made the same. Accordingly, unevenness in the amount of light and unevenness in brightness can be prevented from occurring in the image forming apparatus 80.

Besides, when the movable mirror 76 is once brought into the OFF state before the switching, since the displacement of the movable mirror 76 is not made OFF but made the flat position, the elapsed time before the state is switched can be shortened, and the image forming apparatus superior in high speediness can be realized. Besides, the elapsed time before the movable mirror 76 is once brought into the OFF state before the switching can also be shortened.

Besides, while the drive bias voltage Vb is lowered, at least part of the drive data based on the image is written, and therefore, the drive cycles T1 and T2 can be shortened, and the image forming apparatus excellent in high speediness can be realized.

In the case of FIG. 4C, in a former drive cycle T1, when the displacement of the movable mirror 76 is ON, the drive control part 14 lowers the drive bias voltage Vb applied to the movable mirror 76 until the displacement of the movable mirror 76 has the flat position. By this, the displacement of the movable mirror 76 transitions from ON to the flat position, and at a time point when the displacement exceeds the optical threshold and is placed on the flat position side, the movable mirror 76 is brought into the OFF state and the output of the image forming apparatus 80 becomes OFF.

While the drive bias voltage Vb is lowered, the drive data writing part 13 writes drive data 10a (data for causing the displacement of the movable mirror 76 to be OFF) based on an image into the memory circuit of the SLM 70. After writing, the drive control part 14 returns the lowered drive bias voltage Vb to the original one. By this, a next drive cycle T2 is started, the displacement of the movable mirror 76 transitions from the flat position to OFF, the movable mirror 76 is brought into the OFF state based on the image, and the optical output of the image forming apparatus 80 becomes OFF based on the image.

In the drive cycle T2, when the displacement of the movable mirror 76 is OFF according to the drive data 10a, the drive control part 14 lowers the drive bias voltage Vb applied to the movable mirror 76 until the displacement of the movable mirror 76 has the flat position. By this, the displacement of the movable mirror 76 transitions from OFF to the flat position, the movable mirror 76 keeps the OFF state, and the optical output of the image forming apparatus 80 keeps OFF.

While the drive bias voltage Vb is lowered, the drive data writing part 13 writes drive data 10b (data for causing the displacement of the movable mirror 76 to be ON or OFF) based on a new image into the memory circuit of the SLM 70, and ends the drive cycle T2.

In the case of FIG. 4D, in a former drive cycle T1, when the displacement of the movable mirror 76 is OFF, the drive control part 14 lowers the drive bias voltage Vb applied to the movable mirror 76 until the displacement of the movable mirror 76 has the flat position. By this, the displacement of the movable mirror 76 transitions from OFF to the flat position, the movable mirror 76 keeps the OFF state, and the optical output of the image forming apparatus 80 keeps OFF.

While the drive bias voltage Vb is lowered, the drive data writing part 13 writes drive data 10a (data for causing the displacement of the movable mirror 76 to be OFF) based on an image into the memory circuit of the SLM 70. After writing, the drive control part 14 returns the lowered drive bias voltage Vb to the original one. By this, a next drive cycle T2 is started, the displacement of the movable mirror 76 transitions from the flat position to OFF, the movable mirror 76 is brought into the OFF state based on the image, and the optical output of the image forming apparatus 80 becomes OFF based on the image.

In the drive cycle T2, when the displacement of the movable mirror 76 is OFF according to the drive data 10a, the drive control part 14 lowers the drive bias voltage Vb applied to the movable mirror 76 until the displacement of the movable mirror 76 has the flat position. By this, the displacement of the movable mirror 76 transitions from OFF to the flat position, the movable mirror 76 keeps the OFF state, and the optical output of the image forming apparatus 80 keeps OFF.

While the drive bias voltage Vb is lowered, the drive data writing part 13 writes drive data 10b (data for causing the displacement of the movable mirror 76 to be ON or OFF) based on a new image into the memory circuit of the SLM 70, and ends the drive cycle T2.

As shown in FIGS. 4C and 4D, in both of the case where the optical output of the image forming apparatus 80 is switched from ON to OFF based on the image desired to be formed, and the case where the optical output of the image forming apparatus 80 is switched from ON to OFF based on the image desired to be formed, the drive bias voltage Vb is lowered before the switching, the movable mirror 76 is once brought into the OFF state, and the switching to the optical output OFF of the image forming apparatus 80 is performed in this state. Thus, the optical output ON is not kept after the switching, and the production of leak light can be suppressed. Accordingly, the lowering of contrast in the image forming apparatus 80 can be suppressed.

Besides, when the movable mirror 76 is once brought into the OFF state before the switching, since the displacement of the movable mirror 76 is not made OFF but made the flat position, the elapsed time before the state is switched can be shortened, and the image forming apparatus excellent in high speediness can be realized. Besides, the elapsed time before the movable mirror 76 is once brought into the OFF state before the switching can also be shortened.

Besides, while the drive bias voltage Vb is lowered, at least part of the drive data based on the image is written, and therefore, the drive cycles T1 and T2 can be shortened, and the image forming apparatus excellent in high speediness can be realized.

Additionally, in this embodiment, although the drive data 10a and 10b may be written at any time in the drive cycles T1 and T2, it is desirable to write them after the movable mirror 76 is brought into the ON state or the OFF state according to the drive data based on the image. Besides, although the drive bias voltage Vb may be lowered at any time in the drive cycles T1 and T2, it is desirable to lower the voltage after the movable mirror 76 is brought into the ON state or the OFF state according to the drive data based on the image.

Besides, in this embodiment, although the movable mirror 76 is displaced to the flat position by controlling only the drive bias voltage Vb, the movable mirror 76 can be displaced to the flat position by controlling only the address voltages Va1 and Va2, or by controlling both the drive bias voltage Vb and the address voltages Va1 and Va2.

Besides, in this embodiment, a period from a time when the displacement of the movable mirror 76 is caused to transition to the state corresponding to the drive data based on the image to a time when it is caused to transition to the state corresponding to the drive data based on the new image corresponds to the drive cycle T1 or T2.

### Third Embodiment

An image forming apparatus, such as an exposure device or a projector, for description of a third embodiment of the invention has the same structure as the image forming apparatus 80 shown in FIGS. 10A to 10C. Thus, in the following, the description will be made while using FIGS. 7, 9 and 10 as the need arises.

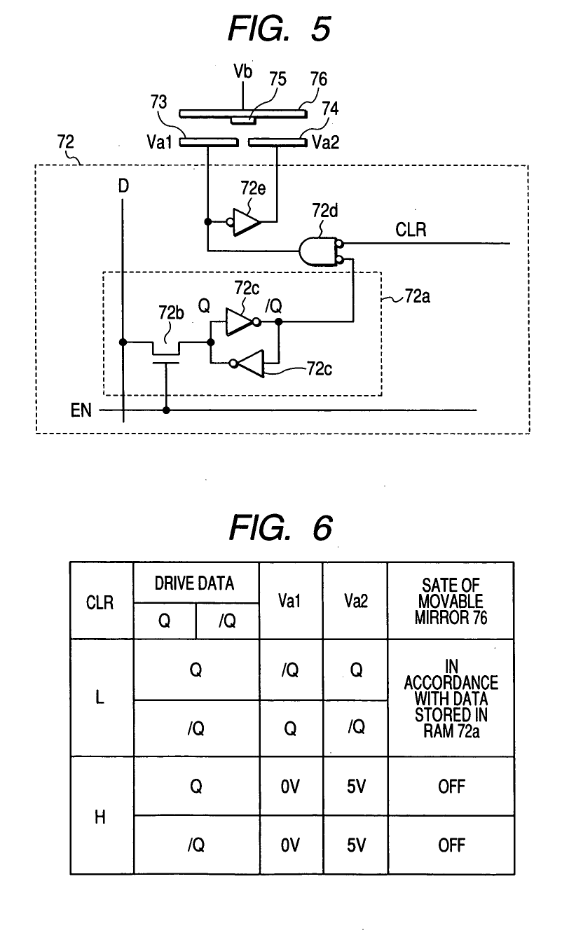

FIG. 5 is a view showing an equivalent circuit of a drive circuit 72 of an SLM 70 for explaining the third embodiment of the invention. The same components as those of FIG. 2 are denoted by same characters. FIG. 6 is a view showing an input/output table of an AND circuit included in a drive circuit of the SLM and for explaining the third embodiment of the invention.

The drive circuit 72 of the SLM 70 shown in FIG. 5 is such that an AND circuit 72d and a NOT circuit 72e are added to the drive circuit 72 shown in FIG. 2.

Data (Q or /Q) from a NOT circuit 72c of an SRAM 72a and a specified signal (clear signal (CLR)) from an after-mentioned drive control part are inputted to the AND circuit 72d. As shown in FIG. 6, the AND circuit 72d outputs the drive data Q and /Q stored in the SRAM 72a as they are when the clear signal is L, and outputs such drive data that the displacement of the movable mirror 76 becomes OFF (for example, such drive data that Va1 becomes 0 V and Va2 becomes 5 V) when the clear signal is H. The SLM 70 of this embodiment is constructed such that even in the case where the clear signal is inputted to the AND circuit 72d, the drive data stored in the SRAM 72a is not deleted. Additionally, the structure may be such that in the case where the clear signal is inputted to the AND circuit 72d, the drive data is deleted.

FIG. 7 is a view showing a rough structure of a light modulating device to be mounted in an image forming apparatus such as an exposure device or a projector for explaining the third embodiment of the invention. The same components as those of FIG. 1 are denoted by same characters and will be explained.

A light modulating device 30 of FIG. 7 includes an SLM array 12, a drive data writing part 13, a drive control part 34, a row selection part 15, and a writing control part 16 for controlling the drive data writing part 13 and the row selection part 15.

The drive control part 34 applies the drive bias voltage Vb to the hinge part 75 and the movable mirror 76 of each of N SLMs 70 included in each SLM row 11, and controls the applied drive bias voltage Vb to control the displacement state of the movable mirror 76.

Additionally, the control of the drive bias voltage Vb can be performed in a unit of arbitrary rows, such as a unit of a row, a unit of a block of plural rows, or a unit of all rows. For example, in the case of the control in the unit of a row, after the drive data is written into a specified row, the drive bias voltages Vb of the specified row are simultaneously controlled, and the displacement states of the movable mirrors of the specified row are simultaneously controlled. In the case of the control in the unit of a block of plural rows, after the drive data is written into the respective rows of the specified block, the drive bias voltages Vb of the specified block are simultaneously controlled, and the displacement states of the movable mirrors are simultaneously controlled. In the case of the control in the unit of all rows, after drive data are written into all rows, the drive bias voltages Vb of all the rows are simultaneously controlled, and the displacement states of the movable mirrors are simultaneously controlled.

Hereinafter, the operation of the image forming apparatus 80 equipped with the light modulating device 30 shown in FIG. 7 will be described.

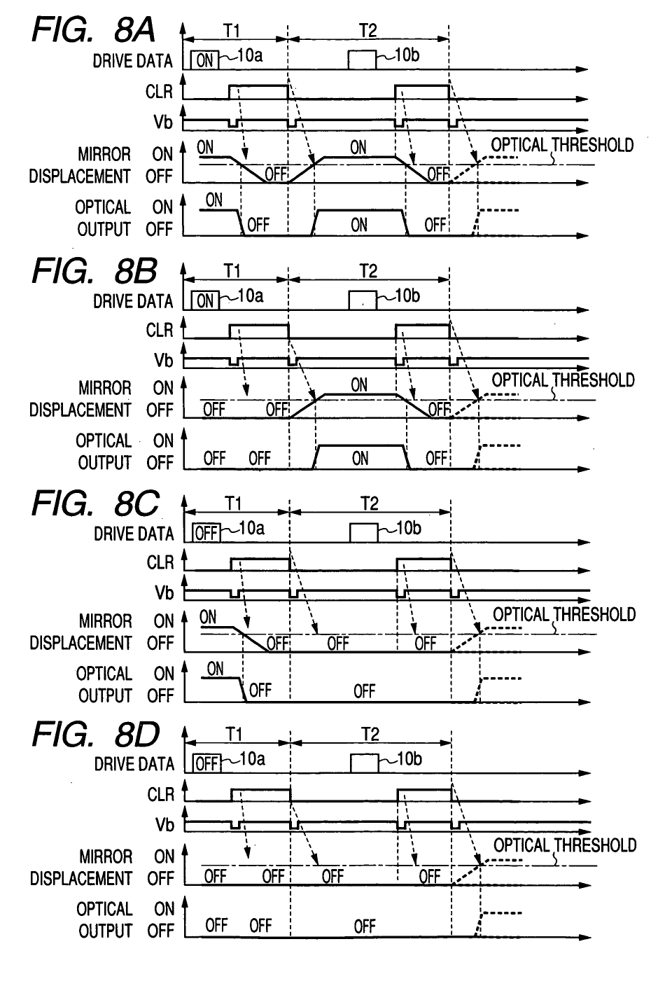

FIGS. 8A to 8D are timing charts for explaining the operation of the image forming apparatus 80 equipped with the light modulating device 10 and for explaining the third embodiment of the invention.

FIG. 8A is a timing chart at the time when the optical output of the image forming apparatus 80 is switched from ON to ON based on an image, FIG. 8B is a timing chart at the time when the optical output of the image forming apparatus is switched from OFF to ON based on an image, FIG. 8C is a timing chart at the time when the optical output of the image forming apparatus is switched from ON to OFF based on an image, and FIG. BD is a timing chart at the time when the optical output of the image forming apparatus 80 is switched from OFF to OFF based on an image. In FIGS. 8A to 8D, it is assumed that when the movable mirror 76 is in a left final displacement state, the displacement of the movable mirror 76 is ON, and when the movable mirror is in a right final displacement state, the displacement of the movable mirror 76 is OFF.

Additionally, in FIGS. 8A to 8D, a period in which the optical output of the image forming apparatus 80 is driven to ON or OFF based on an image desired to be formed is denoted by a drive cycle T1 or T2. The light modulating device 10 repeats this drive cycle T1 or T2, and performs light modulation to form the image on an image formation surface.

In the case of FIG. 8A, in a former drive cycle T1, when the displacement of the movable mirror 76 is ON, the drive data writing part 13 writes drive data 10a (data for causing the displacement of the movable mirror 76 to be ON) based on an image into the memory circuit of the SLM 70. By this, the drive data 10a based on the image is stored in the SRAM 72a. Thereafter, the drive control part 34 causes the clear signal inputted to the AND circuit 72d to be H, and lowers the drive bias voltage Vb applied to the hinge part 75 of the SLM 70 and the movable mirror 76 for a specified time. By this, the displacement of the movable mirror 76 transitions from ON to OFF, and at a time point when the displacement exceeds the optical threshold and is placed on the OFF side, the movable mirror 76 is brought into the OFF state, and the optical output of the image forming apparatus 80 becomes OFF.

The drive control part 34 causes the clear signal to be L after the displacement of the movable mirror 76 becomes OFF according to the clear signal, and lowers the drive bias voltage Vb applied to the hinge part 75 of the SLM 70 and the movable mirror 76 for a specified time. By this, a next drive cycle T2 is started, the displacement of the movable mirror 76 starts to transition from OFF to ON, and at a time point when the displacement exceeds the optical threshold and is placed on the ON side, the movable mirror 76 is brought into the ON state based on the image, and the optical output of the image forming apparatus 80 becomes ON based on the image.

In the drive cycle T2, when the displacement of the movable mirror 76 is ON according to the drive data 10a, the drive data writing part 13 writes drive data 10b (data for causing the displacement of the movable mirror 76 to be ON or OFF) based on a new image into the memory circuit of the SLM 70. By this, the drive data 10b based on the new image is stored in the SRAM 72a. Thereafter, the drive control part 34 causes the clear signal inputted to the AND circuit 72d to be H, and lowers the drive bias voltage Vb applied to the hinge part 75 of the SLM 70 and the movable mirror 76 for a specified time. By this, the displacement of the movable mirror 76 transitions from ON to OFF, and at a time point when the displacement exceeds the optical threshold and is placed on the OFF side, the movable mirror 76 is brought into the OFF state, and the optical output of the image forming apparatus 80 becomes OFF.

The drive control part 34 causes the clear signal to be L after the displacement of the movable mirror 76 becomes OFF according to the clear signal, and lowers the drive bias voltage Vb applied to the hinge part of the SLM 70 and the movable mirror 76 for a specified time. By this, the drive cycle T2 is ended, and a next drive cycle starts.

In the case of FIG. 8B, in a former cycle T1, when the displacement of the movable mirror 76 is OFF, the drive data writing part 13 writes drive data 10a (data for causing the displacement of the movable mirror 76 to be ON) based on an image into the memory circuit of the SLM 70. By this, the drive data 10a based on the image is stored in the SRAM 72a. Thereafter, the drive control part 34 causes the clear signal inputted to the AND circuit 72d to be H, and lowers the drive bias voltage Vb applied to the hinge part 75 of the SLM 70 and the movable mirror 76 for a specified time. By this, the displacement of the movable mirror 76 is kept to be OFF, and the optical output of the image forming apparatus 80 keeps OFF.

The drive control part 34 causes the clear signal to be L after the displacement of the movable mirror 76 becomes OFF according to the clear signal, and lowers the drive bias voltage Vb applied to the hinge part 75 of the SLM 70 and the movable mirror 76 for a specified time. By this, a next drive cycle T2 is started, the displacement of the movable mirror 76 starts to transition from OFF to ON, and at a time point when the displacement exceeds the optical threshold and is placed on the ON side, the movable mirror 76 is brought into the ON state based on the image, and the optical output of the image forming apparatus 80 becomes ON based on the image.

In the drive cycle T2, when the displacement of the movable mirror 76 is ON according to the drive data 10a, the drive data writing part 13 writes drive data 10b (data for causing the displacement of the movable mirror 76 to be ON or OFF) based on a new image into the memory circuit of the SLM 70. By this, the drive data 10b based on the new image is stored in the SRAM 72a. Thereafter, the drive control part 34 causes the clear signal inputted to the AND circuit 72d to be H, and lowers the drive bias voltage Vb applied to the hinge part 75 of the SLM 70 and the movable mirror 76 for a specified time. By this, the displacement of the movable mirror 76 transitions from ON to OFF, and at a time point when the displacement exceeds the optical threshold and is placed on the OFF side, the movable mirror 76 is brought into the OFF state, and the optical output of the image forming apparatus 80 becomes OFF.

The drive control part 34 causes the clear signal to be L after the displacement of the movable mirror 76 becomes OFF according to the clear signal, and lowers the drive bias voltage Vb applied to the hinge part of the SLM 70 and the movable mirror 76 for a specified time. By this, the drive cycle T2 is ended, and a next drive cycle starts.

As shown in FIGS. 8A and 8B, according to the light modulating device 30 of this embodiment, in both of the case where the optical output of the image forming apparatus 80 is switched from ON to ON based on the image desired to be formed, and the case where the optical output of the image forming apparatus 80 is switched from OFF to ON based on the image desired to be formed, the clear signal is caused to be H before switching, the movable mirror 76 is forcibly brought into the OFF state, and the switching to the optical output ON of the image forming apparatus is performed in this state, and therefore, the time of the optical output ON after the switching can be made the same. Accordingly, unevenness in the amount of light and unevenness in brightness can be prevented from occurring in the image forming apparatus 80.

Besides, even in the case where the clear signal becomes H, since the drive data based on the image stored in the SRAM 72a is kept as it is, writing of the drive data can be made at any time. Thus, for example, when the writing of the drive data based on the image is performed in the period when the clear signal is H, the drive cycle time can be shortened.

In the case of FIG. 8C, in a former drive cycle T1, when the displacement of the movable mirror 76 is ON, the drive data writing part 13 writes drive data 10a (data for causing the displacement of the movable mirror 76 to be OFF) based on an image into the memory circuit of the SLM 70. By this, the drive data 10a based on the image is stored in the SRAM 72a. Thereafter, the drive control part 34 causes the clear signal inputted to the AND circuit 72d to be H, and lowers the drive bias voltage Vb applied to the hinge part 75 of the SLM 70 and the movable mirror 76 for a specified time. By this, the displacement of the movable mirror 76 transitions from ON to OFF, and at a time point when the displacement exceeds the optical threshold and is placed on the OFF side, the movable mirror 76 is brought into the OFF state, and the optical output of the image forming apparatus 80 becomes OFF.

The drive control part 34 causes the clear signal to be L after the displacement of the movable mirror 76 becomes OFF according to the clear signal, and lowers the drive bias voltage Vb applied to the hinge part of the SLM 70 and the movable mirror 76 for a specified time. By this, a next drive cycle T2 is started, the displacement of the movable mirror 76 is kept to be OFF, the movable mirror 76 is brought into the OFF state based on the image, and the optical output of the image forming apparatus 80 becomes OFF based on the image.

In the drive cycle T2, when the displacement of the movable mirror 76 is OFF according to the drive data 10a, the drive data writing part 13 writes drive data 10b (data for causing the displacement of the movable mirror 76 to be ON or OFF) based on a new image into the memory circuit of the SLM 70. By this, the drive data 10b based on the new image is stored in the SRAM 72a. Thereafter, the drive control part 34 causes the clear signal inputted to the AND circuit 72d to be H, and lowers the drive bias voltage Vb applied to the hinge part 75 of the SLM 70 and the movable mirror 76 for a specified time. By this, the displacement of the movable mirror 76 is kept to be OFF, and the optical output of the image forming apparatus 80 keeps OFF.

The drive control part 34 causes the clear signal to be L after the displacement of the movable mirror 76 becomes OFF according to the clear signal, and lowers the drive bias voltage Vb applied to the hinge part of the SLM 70 and the movable mirror 76 for a specified time. By this, the drive cycle T2 is ended, and a next drive cycle is started.

In the case of FIG. 8D, in a former drive cycle T1, when the displacement of the movable mirror 76 is OFF, the drive data writing part 13 writes drive data 10a (data for causing the displacement of the movable mirror 76 to be OFF) based on an image into the memory circuit of the SLM 70. By this, the drive data 10a based on the image is stored in the SRAM 72a. Thereafter, the drive control part 34 causes the clear signal inputted to the AND circuit 72d to be H, and lowers the drive bias voltage Vb applied to the hinge part 75 of the SLM 70 and the movable mirror 76 for a specified time. By this, the displacement of the movable mirror 76 is kept to be OFF, and the optical output of the image forming apparatus 80 keeps OFF.

The drive control part 34 causes the clear signal to be L after the displacement of the movable mirror 76 becomes OFF according to the clear signal, and lowers the drive bias voltage Vb applied to the hinge part of the SLM 70 and the movable mirror 76 for a specified time. By this, a next drive cycle T2 is started, the displacement of the movable mirror 76 is kept to be OFF, the movable mirror 76 is brought into the OFF state based on the image, and the optical output of the image forming apparatus 80 becomes OFF based on the image.

In the drive cycle T2, when the displacement of the movable mirror 76 is OFF according to the drive data 10a, the drive data writing part 13 writes drive data 10b (data for causing the displacement of the movable mirror 76 to be ON or OFF) based on a new image into the memory circuit of the SLM 70. By this, the drive data 10b based on the new image is stored in the SRAM 72a. Thereafter, the drive control part 34 causes the clear signal inputted to the AND circuit 72d to be H, and lowers the drive bias voltage Vb applied to the hinge part 75 of the SLM 70 and the movable mirror 76 for a specified time. By this, the displacement of the movable mirror 76 is kept to be OFF, and the optical output of the image forming apparatus 80 keeps OFF.

The drive control part 34 causes the clear signal to be L after the displacement of the movable mirror 76 becomes OFF according to the clear signal, and lowers the drive bias voltage Vb applied to the hinge part of the SLM 70 and the movable mirror 76 for a specified time. By this, the drive cycle T2 is ended, and a next drive cycle is started.

As shown in FIGS. 8C and 8D, according to the light modulating device 30 of this embodiment, in both of the case where the optical output of the image forming apparatus 80 is switched from ON to OFF based on the image desired to be formed, and the case where the optical output of the image forming apparatus 80 is switched from OFF to OFF based on the image desired to be formed, the clear signal is caused to be H before switching, and the movable mirror 76 is forcibly brought into the OFF state, and the switching to the optical output OFF of the image forming apparatus 80 is performed in this state, and therefore, the optical output ON is not kept after the switching. Additionally, the production of leak light can be prevented, unevenness in the amount of light and unevenness in brightness can be prevented from occurring in the image forming apparatus 80, and the lowering of contrast can be prevented.

Besides, even in the case where the clear signal becomes H, since the drive data based on the image and stored in the SRAM 72a is kept as it is, writing of the drive data can be performed at any time.

Thus, for example, the drive cycle time can be shortened by performing the writing of the drive data based on the image in the period in which the clear signal is H.

Besides, when the structure is such that in the case where the clear signal becomes H, the drive data stored in the SRAM 72a is deleted, the writing of the drive data based on the image may be performed after the clear signal is once made L.

Additionally, in this embodiment, in the drive cycles T1 and T2, as long as the movable mirror 76 has been brought into the ON state or the OFF state according to the drive data based on the image, the clear signal may be made H at any time. Besides, the drive data 10a and 10b may be written at any time in the drive cycles T1 and T2.

Besides, in the embodiment, a period from a time when the displacement of the movable mirror 76 is caused to transition to the state corresponding to the drive data based on the image to a time when it is caused to transition to the state corresponding to the drive data based on the new image corresponds to the drive cycle T1 or T2.

Besides, as long as the gist of the invention is satisfied, the circuit structures and the drive sequences described in the first to the third embodiments may be any structures and any methods other than the above.

Besides, in the first to the third embodiments, as the light modulator, the reflection type light deflecting mirror element typified by the SLM 70 is used as an example and the description has been made, however, the structure of the element, the light modulation principle and the like are not limited to this. For example, a transmission type may be adopted, or an optical phase modulation, a light shutter, a diffraction control or the like may be adopted. Besides, the invention is not limited to the light modulator having the light modulation part of the micro-electro-mechanical control system, and the same effects can be obtained also in a case where a liquid crystal element, an electro-optic crystal element, or a magneto-optic crystal element is adopted.

1. A drive method of a spatial light modulator array, the spatial light modulator array including plural spatial light modulators each comprising: a storage part for storing drive data; and a light modulating part capable of taking at least an ON state to allow light to be emitted and an OFF state to prohibit light from being emitted according to the drive data,
the method comprising:
writing the drive data in the storage part; and
changing a state of the light modulating part according to the drive data, thereby performing a light modulation,
wherein a control is performed to cause the light modulating part to have the OFF state within a period from a transition to a first state corresponding to first drive data based on a first image to a transition to a second state corresponding to second drive data based on a second image, and in this state, the light modulating part is caused to transition to the second state.

2. The drive method according to claim 1, wherein the control is performed by writing OFF state drive data, which causes the light modulating part to have the OFF state, into the storage part, and by changing the light modulating part into the OFF state according to the written OFF state drive data.

3. The drive method according to claim 1, wherein the light modulator causes the light modulating part to have the OFF state according to input of a signal independently of the drive data stored in the storage part, and
the control is performed by changing the light modulating part into the OFF state by the input of the signal.

4. The drive method according to claim 3, wherein even in a case where the signal is inputted, the storage part keeps the second drive data.

5. The drive method according to claim 1, wherein the light modulating part comprises a movable part supported to be capable of being elastically displaced and provided with a movable electrode, and a fixed electrode disposed to face the movable part, and can take at least the ON state and the OFF state by displacing the movable part by an electrostatic force generated according to application of a drive voltage to the movable electrode and the fixed electrode.

6. The drive method according to claim 5, wherein the control is performed by controlling the drive voltage applied to at least one of the movable electrode and the fixed electrode.

7. The drive method according to claim 6, wherein
the movable part comprises a mirror capable of being displaced in a direction varying according to the electrostatic force,
the mirror is tilted in a first direction in a final state of the ON state, and is tilted in a second direction opposite to the first direction in a final state of the OFF state, and
the control is performed by controlling the drive voltage to produce a state in which the mirror is not tilted in either of the first direction and the second direction.

8. The drive method according to claim 1, wherein
the light modulator comprises a movable part supported to be capable of being elastically displaced and provided with a movable electrode, and a fixed electrode disposed to face the movable part, and can take at least the ON state and the OFF state by displacing the movable part by an electrostatic force generated by application of a drive voltage to the movable electrode and by application of a voltage to the fixed electrode according to the drive data, and
the movable part comprises a mirror capable of being displaced in a direction varying according to the electrostatic force.

9. The drive method according to claim 1, wherein even in a case where the drive data is written in the storage part when the light modulating part is in one of the ON state and the OFF state, the light modulator has a latch function to keep the state.

10. The drive method according to claim 1, wherein writing of at least a part of the second drive data into the storage part is performed when the light modulating part is in the OFF state.

11. A light modulating device comprising:
a spatial light modulator array including plural spatial light modulators each comprising:
a storage part for storing drive data; and
a light modulating part capable of taking at least an ON state to allow light to be emitted and an OFF state to prohibit light from being emitted according to the drive data; and
a light modulating control part which causes the drive data to be written in the storage part, causes a state of the light modulating part to be changed according to the written drive data, and causes light modulation to be performed,
wherein the light modulating control part performs a control to cause the light modulating part to have the OFF state within a period from a transition to a first state corresponding to first drive data based on a first image to a transition to a second state corresponding to second drive data based on a second image, and causes, in this state, the light modulating part to transition to the second state.

12. The light modulating device according to claim 11, wherein the light modulating control part performs the control by writing OFF state drive data, which causes the light modulating part to have the OFF state, into the storage part, and by changing the light modulating part into the OFF state according to the written OFF state drive data.

13. The light modulating device according to claim 11, wherein
the light modulator causes the light modulating part to have the OFF state according to input of a signal independently of the drive data stored in the storage part, and
the light modulating control part performs the control by changing the light modulating part into the OFF state by the input of the signal to the light modulator.

14. The light modulating device according to claim 13, wherein even in a case where the signal is inputted, the storage part keeps the second drive data.

15. The light modulating device according to claim 11, wherein the light modulating part comprises a movable part supported to be capable of being elastically displaced and provided with a movable electrode, and a fixed electrode disposed to face the movable part, and can take at least the ON state and the OFF state by displacing the movable part by an electrostatic force generated according to application of a drive voltage to the movable electrode and the fixed electrode.

16. The light modulating device according to claim 15, wherein the light modulating control part performs the control by controlling the drive voltage applied to at least one of the movable electrode and the fixed electrode.

17. The light modulating device according to claim 16, wherein
the movable part comprises a mirror capable of being displaced in a direction varying according to the electrostatic force,
the mirror is tilted in a first direction in a final state of the ON state, and is tilted in a second direction opposite to the first direction in a final state of the OFF state, and
the light modulating control part performs the control by controlling the drive voltage to produce a state in which the mirror is not tilted in either of the first direction and the second direction.

18. The light modulating device according to claim 11, wherein
the light modulating part comprises a movable part supported to be capable of being elastically displaced and provided with a movable electrode, and a fixed electrode disposed to face the movable part, and can take at least the ON state and the OFF state by displacing the movable part by an electrostatic force generated by application of a drive voltage to the movable electrode and by application of a voltage to the fixed electrode according to the drive data,
the movable part comprises a mirror capable of being displaced in a direction varying according to the electrostatic force, and
the light modulating control part controls the drive voltage applied to the movable electrode.

19. The light modulating device according to claim 11, wherein even in a case where the drive data is written in the storage part when the light modulator is in one of the ON state and the OFF state, the light modulator has a latch function to keep the state.

20. The light modulating device according to claim 11, wherein the light modulating control part performs writing of at least a part of the second drive data into the storage part when the light modulating part is in the OFF state.

21. The image forming apparatus comprising:
a light modulating device according to claim 11;
a light source for causing light to be incident on the spatial light modulator array; and
a projection optical system for projecting light emitted from the spatial light modulator array onto an image formation surface.
